(19) United States
(12) Patent Application Publication
(10) Pub. No.: US 2009/0004496 A1
(43) Pub. Date: Jan. 1, 2009

(54) System for Providing Powder Coated Reconstituted Cellulosic Substrate

(75) Inventors: Alexander Mark Bruce, Tauranaga (NZ); Noel Francis Dunlop, Victoria (AU); David Murray James, Victoria (AU)

Correspondence Address: ARENT FOX LLP, 1050 CONNECTICUT AVENUE, N.W., SUITE 400, WASHINGTON, DC, 20036, US

(73) Assignee: Orica Australia Pty Ltd, Melbourne, Victoria (AU)

(21) Appl. No.: 11/632,775

(22) PCT Filed: Jul. 27, 2004
(86) PCT No.: PCT/AU2004/001002

§ 371 Date: Apr. 17, 2008

(51) Int. Cl. B32B 21/04; B05D 3/02; C08K 3/30

(52) U.S. Cl. 428/537.1; 427/195; 524/423

(57) ABSTRACT

A process for preparing a powder coated reconstituted cellulosic substrate comprising providing a reconstituted cellulosic substrate comprising cellulose based particles and a cured formaldehyde based resin, wherein an inorganic salt is dispersed throughout the substrate; applying a powder coating composition to at least one surface of said substrate; and curing the powder coating composition.

### FIELD OF THE INVENTION

The present invention relates to reconstituted cellulosic substrates for powder coating and a system for providing powder coated reconstituted cellulosic substrates. The invention includes a binder composition for use in the manufacture of reconstituted cellulosic substrates, and a process for applying a powder coating to reconstituted cellulosic substrates prepared from the binder composition.

### BACKGROUND TO THE INVENTION

Cellulosic substrates include a wide variety of engineered wood products and nowadays are commonly used in construction. These engineered wood products may be preferred over natural timber as the engineered products can consistently meet the same quality standards. They are sometimes referred to as lignocellulose products. Cellulosic products include plywood, a laminate formed from layers of natural timber or engineered wood products, and also reconstituted cellulosic substrates.

Reconstituted cellulosic substrate, sometimes referred to as reconstituted wood substrate (“RWS”), is a substrate produced from wood particles such as wood dust or floor, fibres, flakes or chips. Common examples of RWS include particle board, chip board, flake board, medium density fibreboard (“MDF”), high density fibreboard, hard board, strand board and wafer board. RWS is typically produced by combining the particles, fibres, flakes or chips with a binder and pressing into the form of a panel. For the purposes of this invention reconstituted cellulosic substrate or RWS does not include paper products.

The binders used in RWS are generally formaldehyde based resins, such as urea formaldehyde (“UF”) resins, phenol formaldehyde (“PF”) resins, phenol urea formaldehyde (“PUF”) resins, melamine urea formaldehyde (“MUF”) resins, phenol melamine urea formaldehyde (“PMUF”) resins or phenol melamine formaldehyde (“PMF”) resins. These resins are sometimes used together with an isocyanate, such as 4,4N-methylenebis (phenyl isocyanate) (“MDI”). In referring to these resin compositions and other formaldehyde-based resin compositions throughout the present specification the non-formaldehyde monomer component of the resin will be referred to as the “co-monomer”. While selection of appropriate co-monomers can increase the water resistance of the resultant reconstituted cellulosic composite panels, reconstituted cellulosic composite panels are generally sensitive to the presence of water in any surface coating.

RWS have limitations dependent on the type of substrate and the binder used. Most RWS are water sensitive and steps must be taken to protect the substrate. Those RWS which are less water sensitive are typically more expensive due to the higher resin content and this may also result in greater UV sensitivity and yellowing of the surface binder resin. Furthermore, by and large RWS is not as ascetically pleasing as natural timber products.

RWS may be protected against the elements and the appearance improved by the use of coatings such as foils, laminates, veneer, paint or the like. For example, particle board, as now commonly used for flooring, may be stained and resin coated to both protect the particle board from water damage and improve the look of the flooring. However, when painted or stained, they are generally painted with either solvent containing products which release solvents and other VOC's (Volatile Organic Compounds) to the environment or with water based products. Water based paints generally still contain some VOC's which are released to the environment. The water based products can also cause fibre raising due to the wood fibres or particles in the substrate absorbing water and swelling giving a poor surface finish.

In order to avoid the problems associated with the water sensitivity of reconstituted cellulosic substrates, and to avoid or minimise the use of VOC's, considerable research has been conducted to develop methods of applying powder coatings to panels of reconstituted cellulosic substrates. In addition to avoiding or minimising the use of VOC's, the use of powder coating techniques provides an additional advantage in that powder not adhering to the reconstituted cellulosic composite panel in the first spray application can be recycled and reused. This is not possible using solvent or water based coatings where any product that does not adhere to the panel during application is lost to the environment. It can also reduce labour costs in building construction by removing the need to stain and resin coat RWS flooring.

In general it is difficult to successfully power coat materials which were temperature sensitive, such as panels of RWS. The high curing temperatures associated with powder coatings (generally about 200° C. or higher) result in distortion or internal splitting (checking) of the panels and outgassing (causing surface defects—pin holing) from the release of moisture and other volatiles from the panels. A further problem associated with the powder coating of composite wood is the low adhesion of the powder to the panel. Since the coverage is highly dependent on electrostatic fields surrounding the panel, poor coverage is often a particular problem at the edges of the panel. Several attempts at solving the problems associated with the powder coating of reconstituted cellulosic composite panels have been described in the literature.

U.S. Pat. No. 4,530,778 (Nelson, et al) describes a pre-treatment solution for rendering wood electrostatically coatable. The solution comprises water and/or organic solvents organic quaternary ammonium compound, low volatile polyol and inorganic salts such as ammonium, magnesium or calcium chloride.

U.S. Pat. No. 6,153,267 (Horinka et al) describes a process for coating the surfaces of porous substrates, including particle board and MDF, which involves preheating the substrate to a temperature between 130° F. (55° C.) and 300° F. (150° C.) followed by the application to the substrate of atomised water or other aqueous solution. This pretreatment step is said to increase the charge carrying capacity of the substrate and improve adhesion of the powder coats.

U.S. Pat. No. 6,458,250 (Holliday et al) describes a similar system to Horinka above. The board is treated with steam and heat (70° C. to 140° C.) for a short period before the application of the powder coating.

U.S. Pat. No. 6,146,710 (Symons) describes a process which involves impregnating a lignocellulosic material, including chipboard or fibreboard, with a di or tri carboxylic anhydride, or an isocyanate thermosetting resin, in non-aqueous solvent. The residual carboxylic acid groups are said to have a dielectric loss factor which allows the modified lignocellulosic to conduct electricity.

U.S. Pat. No. 6,214,421 (Pidzanko) describes a process for pretreating a wood substrate which involves cleaning the surface of the substrate followed by spraying water at a relative humidity of not less than 100%. This pretreatment is said to improve adherence of the powder coat.

U.S. Pat. No. 6,136,370 (Muthiah et al) describes a method for improving the adherence of a powder coat to the front surface of a cellulosic substrate (wood or fibreboard) and reducing cracking which involves routing and machining the rear surface of the substrate.

U.S. Pat. No. 5,851,667 (Horinka et al) describes a powder coat material having a particular particle size distribution which is said to be particularly useful in coating wood substrates using a triboelectric spray system.

U.S. Pat. RE 36,742 (Correll et al) (a reissue of U.S. Pat. No. 5,714,206) describes a method of preparing a powder coating material for use in coating heat sensitive substrates which involves the use of a low temperature curing agent. The problems associated with incorporating a low temperature curing agent in the resin composition for extrusion were addressed by separately blending the curing agent with the extruded and pulverised coating material.

EP 933140 A1 (Mayger) describes a process whereby the conductivity of an MDF panel is increased by increasing the temperature of the panel to between 40° C. and 100° C. during the coating step.

U.S. Pat. No. 6,537,671 (Muthiah) describes a powder coating formulation having enhanced electrostatic chargeability for use on substrates like wood composition materials, including particle board and electrically conductive particle board (ECP).

U.S. Pat. No. 6,005,017 (Daly et al) describes the use of dual thermal and ultraviolet curable powder coating compositions for powder coating heat sensitive substrates such as wood compositions. A UV initiator is used to cure at the surface and a thermal initiator is used to cure at the substrate. This arrangement provides reduced curing temperatures and times.

As is evident from the above, most prior attempts have involved pretreatment of the manufactured substrate or powder coating formulation strategies.

There have also been a number of attempts to produce particle board with enhanced electrical conductivity for other purposes.

U.S. Pat. No. 4,906,484 (Lambuth. et al) describes electrically conductive medium and high density particle board for use in the manufacture of flooring, wall paneling and furniture to provide static free environments. The binder used in the formation of boards contains electrically conductive carbon particles. The particle board of this invention appears to correspond to the commercial product referred to as Electrically Conductive Particleboard (ECP®) initially provided by the Boise Cascade Corporation and nowadays by Eagle Manufacturing LLC.

The patent includes a description of a series of experiments from which it is concluded that there are manifold problems with the manufacture of electrically conducting boards using lignocellulose and limited solutions. Electrical conductivity was considered to require the use of wood particles of a specific size, metal powders and carbon particles. Electrically conductive metal powders and salts (NaCl, borax/boric acid and zirconate salts) comprising up to 17% by weight of the resin binder in the instance of NaCl were considered unsuitable with the board having infinite electrical resistance.

U.S. Pat. No. 6,348,119 (Leonte et al) describes a method of curing particle board by forming a temporarily conductive particle board from high moisture content wood particles, an electrolyte and a typical resin adhesive (the binder). A large number of electrolytes were suggested and include metallic salts, carbon black, metallic powders and electroconductive polymers. The mixture is prepressed into a desired shape and current is passed therethrough to electrically heat and cure the resin. It avoids the need to use hot presses and reduces the amount of VOC released during board formation. No specific examples were provided.

It has now been found that improved adherence of powder coatings to RWS can be achieved by utilising a suitable formaldehyde-based resin formulation in the preparation of the reconstituted cellulosic composite panels.

### SUMMARY OF THE INVENTION

According to an aspect of the invention, there is provided a process for preparing a powder coated reconstituted cellulosic substrate comprising:
providing a reconstituted cellulosic substrate comprising cellulose based particles and a cured formaldehyde based resin, wherein an inorganic salt is dispersed throughout said substrate;
applying a powder coating composition to at least one surface of said substrate; and
curing said powder coating composition.

According to another aspect of the invention, there is provided a reconstituted cellulosic substrate when used in a powder coating process, wherein an inorganic salt is dispersed throughout said substrate.

According to another aspect of the invention, there is provided a reconstituted cellulosic substrate for use in a powder coating process, wherein an inorganic salt is dispersed throughout said substrate.

Preferably the inorganic salt used in the above aspects of the invention is not chloride salt, more preferably not sodium chloride, more preferably the salt is a sulphate salt.

According to another aspect of the present invention there is provided a binder composition for use in the manufacture of reconstituted cellulosic substrate comprising a formaldehyde-based resin and an inorganic sulphate salt.

According to another aspect the present invention there is provided a binder composition for use in the manufacture of reconstituted cellulosic substrate comprising a melamine urea formaldehyde resin and an inorganic sulphate salt.

### DETAILED DESCRIPTION OF THE INVENTION

The presence of an inorganic salt in the binder composition used to form reconstituted cellulosic substrates has been found to result in improved adherence of the powder coating to the composite panel during the powder coating process. The inclusion of the inorganic salt also improves adherence along the edges of the panel. The “edge effect” has been a significant problem with other methods of powder coating reconstituted cellulosic substrates. While not wishing to be limited by theory, it is believed that it is achieved by reducing the Faraday effect. It is thought that the improvement in the powder coating properties of the substrate is as a result of the substrate having increased conductivity.

The inorganic salt may be any inorganic salt which is capable of disassociating into ions within the binder composition. The inorganic salt may be an alkali metal salt, an alkaline earth metal salt, a transition metal salt or an ammonium salt. The inorganic salt may have an anion selected from halogen, sulphate, phosphate, carbonate, thiocyanate or the like. Examples of suitable salts include alkali metal salts such as sodium chloride, sodium sulphate, sodium carbonate, sodium metabisulphate, lithium chloride, potassium chloride, potassium sulphate, sodium hydrogenphosphate, sodium hydrogencarbonate, sodium hydrogensulphate, sodium thiosulphate, potassium phosphate, potassium thiocyanate, lithium carbonate, alkaline earth metal salts, such as magnesium sulphate, magnesium carbonate, magnesium chloride, magnesium bisulphite, calcium sulphate, calcium nitrate, calcium phosphate calcium chloride and ammonium salts such as ammonium chloride.

Preferably the salt is limited to inorganic sulphite or sulphate salts, and more preferably to sulphate salts such as sodium sulphate, calcium sulphate, ammonium sulphate, sodium thiosulphate, potassium sulphate as these salts have been found to provide a number of benefits. Sodium sulphate is readily available at low cost and has a low hazard rating.

The use of inorganic sulphate salts within the resin may also improve the curing of the resin during the substrate manufacturing process.

There are significant benefits in not including chloride containing salts in the substrate. If significant amounts of chloride ions are present throughout the substrate then there is a greater risk of the production of tetrachlorodioxins whenever the substrate is heated such as during the manufacturing process, during the curing of a powder coating and whenever the substrate is burnt. Tetrachlorodioxins are highly toxic chemicals and are thought by some to have been the damaging component of the defoliant known as Agent Orange. The potential, however remote, of forming such chemicals by burning the substrate could result in the commercial failure of the substrate. It is believed that a number of businesses have moved away from using chloride within cellulose containing substrates for this reason. Thus another benefit of using of sulphates (or other non-chloride salts) is that it does not add chloride ions throughout the substrate.

Another benefit with using inorganic sulphates is that they are generally less damaging to the equipment used during board manufacture and elsewhere. In contrast the use of chloride salts such as sodium chloride can lead to significant corrosion to plant equipment during the manufacture of the substrate and can also damage equipment used during the powder coating of the substrate. Moisture can combine with sodium chloride at or near the surface of the substrate and form a salty solution that can facilitate rust formation. Some business effectively ban the use of sodium chloride within manufacturing plants due to the corrosion affect on mild steel.

The inorganic salt should be included in the binder composition in an amount sufficient to increase the conductivity of the resultant reconstituted cellulosic substrate to a level which allows good adherence of the powder coating composition to the substrate prior to curing. Preferably the conductivity of the panel will be greater than 10⁻¹⁰ (Ω·m)⁻¹, more preferably greater than 10⁻⁹ (Ω·m)⁻¹, and most preferably greater than 10⁻⁸. A sufficient amount should be used to improve the adherence of the powder coating by preferably 5% or more preferably 10% as compared to a control (unsalted) sample.

The inorganic salt should also be included in an amount which does not chemically alter the resin, or at least does not adversely affect the ability of the resin to act as a binder for the cellulose based particles. Typically the inorganic salt would be included in an amount from 1-15% by weight of the binder composition, more preferably 2-10%, and most preferably 3-7%. For example the salt, preferably a sulphate salt is present in an amount by weight selected from 1-14%, 1-13%, 1-12%, 1-11%, 1-10%, 1-9%, 1-8%, 1-7%, 1-6%, 1-5%, 1-4%, 1-3%, 2-15%, 2-14%, 2-13%, 2-12%, 2-11%, 2-10%, 2-9%, 2-8%, 2-7%, 3-15%, 3-14%, 3-13%, 3-12%, 3-11%, 3-10%, 3-9%, 3-8%, 3-7%, 3-6%, 3-5%, 4-15%, 4-14%, 4-13%, 4-12%, 4-11%, 4-10%, 4-9%, 4-8%, 4-7%, 4-6%, 5-15%, 5-14%, 5-13%, 5-12%, 5-11%, 5-10%, 5-9%, 5-8%, 5-7%, 6-15%, 6-10%, 7-15%, 7-10%, 8-15% and 8-11% of the resin.

The inorganic salt may be incorporated into the resin composition when or soon after it is manufactured, or it may be added to the resin at a later stage, such as immediately prior to the manufacture of the panel. It is also possible to add the salt component separately during panel manufacture.

As mentioned above formaldehyde based resin is used in the preparation of the reconstituted cellulosic substrate. Formaldehyde-based resins incorporate formaldehyde together with a comonomer or comonomers. As mentioned above, the term “comonomer” is used to refer to one or more comonomers suitable for forming a formaldehyde-based resin.

In binary systems, such as urea-formaldehyde systems, the molar ratio of formaldehyde to comonomer is simply the molar ratio of the formaldehyde to the comonomer (i.e. urea). In ternary or more complex systems, the molar ratio of formaldehyde to comonomer is the molar ratio of the formaldehyde to the sum of the molar amounts of the comonomers.

The formaldehyde-based resin comprises formaldehyde present in a molar ratio of formaldehyde to comonomer is in the range of from about 0.2:1 to about 5:1. Preferably the molar ratio of formaldehyde to comonomer is in the range of about 0.3:1 to about 4:1. More preferably the molar ratio of formaldehyde to comonomer is in the range of from about 0.4:1 to about 3.5:1.

Suitable comonomers for use in the formaldehyde-based resin include polyfunctional amines, phenols, and other comonomers capable of forming copolymers with the formaldehyde.

The polyfunctional amines comprise two or more primary, secondary and or tertiary amine groups. Examples of suitable polyfunctional amines include melamine, urea, guanidines, para-toluene sulfonamide, triazines, thiourea and dicyandiamide. Preferred polyfunctional amines include melamine and urea. Preferably the polyfunctional amine is a combination of urea and melamine. Examples of suitable phenols include phenol, resorcinol, tannins, lignins, bisphenol A, cresol and xylenol.

The formaldehyde-based resin may be selected from the group consisting of UF resins, PF resins, PUF resins, MUF resins, PMUF resins and PMF resins. Preferably the formaldehyde based resin is a MUF resin.

In urea formaldehyde resins it is preferable that the molar ratio of formaldehyde to comonomer is in the range of from about 0.3:1 to about 1.5:1, more preferably from about 0.4:1 to about 1.4:1, even more preferably about 0.5:1 to about 1.3:1, and most preferably about 0.7:1 to about 1.2:1.

In these urea formaldehyde resins part of the urea may be replaced with melamine. The modification of urea formaldehyde resins with melamine has been found to provide particular advantages in the preparation of reconstituted cellulosic substrates for powder coating. In addition to providing improved temperature and dimensional stability in the composite panels, MUF and PMUF resins may also provide improved water resistance.

In a preferred aspect the present invention provides a binder composition for use in the manufacture of reconstituted cellulosic substrate comprising a melamine urea formaldehyde resin and the inorganic salt.

The melamine may replace up to 85% by weight of comonomer. The urea formaldehyde resin modified with melamine may include a melamine component of from about 0.5 to about 60% and preferably from 1 to 50% weight on solids.

Urea formaldehyde resins are preferably formulated to a viscosity of up to about 700 cps and more preferably in the range of about 30 to 600 cps, and more preferable in the range of 30 to 100 cps at 65% solids content and 25° C.

Preferably, the urea formaldehyde resin comprises from about 35% to about 70% by weight solids, more preferably from about 40% to about 70% by weight solids.

Preferably, the urea formaldehyde resin has a pH in the range of from about 7 to about 10, more preferably from about 7.5 to about 9.5.

In phenol formaldehyde resins it is possible to formulate the resin at either acid curing or alkaline curing conditions. Under acid curing conditions it is preferable to use a high phenol content. Preferably the molar ratio of formaldehyde to comonomer is in the range of from about 0.4:1 to about 1:1, more preferably from about 0.4:1 to about 0.9:1, and most preferably about 0.45:1 to about 0.7:1.

Under alkaline curing conditions it is preferable to use a low phenol content. Preferably the molar ratio of formaldehyde to comonomer is in the range of from about 1.8:1 to about 4:1, more preferably from about 2:1 to about 2.5:1, and about 3.5:1 to about 3.8:1.

In these phenol formaldehyde resins part of the phenol may be replaced with urea.

The urea may replace up to 50% weight on solids. Preferably the urea may be present in an amount of from about 1% to about 25% weight on solids.

PF resins are preferably formulated to a viscosity of up to about 400 cps and more preferably in the range of about 30 to 400 cps, most preferably 50 to about 250 cps at 45% solids at 25° C.

Preferably, the phenol formaldehyde resin comprises from about 30% to about 50% by weight solids, more preferably from about 35% to about 45% by weight solids.

Preferably, the phenol formaldehyde resin has a pH in the range of from about 7 to about 12, more preferably from about 9 to about 12, such as from about 10 to about 12.

The binder composition can also include an isocyanate containing compound. If present it is preferably included in an amount of from 0.5 to 50% by weight of the binder composition. If an isocyanate is used it should be kept separate from the remainder of the binder composition until board manufacture.

A variety of additives such as those used in the manufacture of conventional formaldehyde resins may be incorporated into the formulations of the formaldehyde based resin of the present invention. These additives include pH modifying agents such as acids, bases and buffers. Acids typically used may include formic acid, hydrochloric acid, phosphoric, acetic and sulfuric acid. Bases typically used may include sodium hydroxide and potassium hydroxide. Buffers which may be used include triethanolamines triethylamine, ammonia, melamine and borax. Other additives include hexamine, sulphites, polyvinyl alcohol and sodium metabisulfite and cationic diethanolamine salts etc.

The formaldehyde-based resin component may advantageously be blended with a release agent for supply to a fabricator of composite boards. When using isocyanate based binders, fabricators will generally employ release agents to facilitate removal of the boards from the presses. Generally release agents such as waxes are independently applied to the cellulose fibres. The incorporation of release agents into the formaldehyde-based resin allows greater convenience in the manufacturing process as the fabricator may operate a reduced stock inventory. It also reduces likelihood of incorrect dosages being used. Alternatively the release agent may be included in another component of the system, such as in the salt component, or in an isocyanate component if one is used.

Preferably, suitable release agents include paraffin and synthetic waxes such as montan waxes, polyethylene waxes and polypropylene waxes.

If an isocyanate containing compound is incorporated, it may be a polyisocyanate including blocked isocyanates. Suitable polyisocyanates include toluene diisocyanate (“TDI”) and 4,4′-methylenebis (phenyl isocyanate). Preferably the isocyanate containing compound for use in the present invention is 4,4′-methylenebis (phenyl isocyanate) or commercial alternatives, generally referred to in the art as MDI. One example of a suitable MDI is Rubinate DUO B200 (ex Orica Australia Pty Ltd). The isocyanate containing compound may be provided in a variety of forms, such as neat or in an emulsified form.

The isocyanate containing compound when used in the present invention is present in the binder composition in an amount in the range of from 0.5 to 50% by weight of said binder composition. Preferably the isocyanate containing compound is present in the binder composition in an amount in the range of from 5 to 30%, more preferably from 10 to 25%.

In one aspect the formaldehyde-based resin is preferably pre-reacted with up to 50% w/w on resin solids of melamine. The binder composition manufactured from such a pre-reacted formaldehyde-based resin may impart superior cold and hot water swell properties to the composite board, i.e. improved dimensional stability, particularly with reference to heat and moisture.

In another aspect of the invention there is provided a method for the manufacture of a reconstituted cellulosic substrate comprising blending cellulose-based particles with a binder composition comprising a formaldehyde-based resin and an inorganic salt, forming said blend into a preform of said substrate, and curing the binder composition to form said substrate.

Typically the preform of the substrate will be in the shape of a panel as RWS are typically sold in this shape. However, a broad range of preform shapes are possible and substrates of those shapes are also intended to be encompassed by the present invention. Some of the more common non-panel shapes include lengths having circular or semi circular (quad) cross-section.

The cellulose-based particles selected for use in the manufacture of the substrate will be dependant upon the nature of the RWS to be produced. The cellulose-based fibres, particles or chips may be in the form of raw fibres. The cellulose-based fibres, particles or chips may be in the form of fibres which have not been pre-dried. In a method the cellulose-based fibres, particles or chips may be in the form of untreated, moist raw fibres. As mentioned earlier the substrate is RWS, and thus particle board, chip board, flake board, medium density fibreboard (MDF), high density fibreboard, hard board, strand board and wafer board may be manufactured in accordance with the present invention. Other forms of RWS within the scope of the invention include oriented strand board (OSB) as well as combinations, such as tri-board, which is a combination of oriented strand board and medium density fibreboard.

Particle board may be made from small discreet particles of wood, typically dried wood. The wood particles may be made by cutting or breaking of the wood, their shape not being narrowly critical to the construction of the particle board. The particles of dried wood generally contain a moisture content of from 2 to 10% by weight. The manufacture of particle board generally combines a mechanical mixing of the particles and the binder composition followed by the application of heat and pressure so as to cure the resin and form the particle board. Typically the pressing temperatures for curing the resin are in the range of from 130° C. to 240° C. although other temperatures may be possible depending on the formulation. Generally particle boards contain from 3 to 40% by weight of resin, preferably from 5 to 20% by weight of resin and more particularly around 8 to 15% by weight resin.

In a particularly preferred embodiment of the present invention the substrate is medium density fibreboard. The medium density fibreboard comprises cellulose-based fibres which are in the form of a wood pulp. The binder is added to the wood pulp and the mixture dried to form a mat of dried fibres and binder. The temperatures chosen for the drying of the mixture are preferably such that the mixture is dried whilst the binder is not subject to conditions which will induce substantial curing. The dried mat is consolidated into the desired preform which is subsequently subjected to heat and pressure so as to cure the binder and produce the desired composite. The cellulose fibre may be dried at temperatures ranging from 80° C. to 160° C.

According to the method of the present invention the cellulose-based particles are blended with the binder composition. The binder composition may be added as a whole or one or more components of the binder composition may be pre-blended with the cellulose-based particles and the remaining components subsequently combined with the pre-blended materials. For example, the cellulose-based particles may be blended with the formaldehyde-based resin and subsequently a composition containing the inorganic salt and one or more of the monomers are incorporated into the pre-blended composition. Alternatively, a formaldehyde-based resin and an inorganic salt may be blended with the cellulose particles and subsequently further comonomer may be added to the pre-blended components to decrease the molar ratio of formaldehyde to comonomer.

The blending of the cellulose particles with the resin composition may be performed in situ, such as in a blender or a blow line.

Generally the curing of the binder composition to form a composite board may be by the process of hot pressing where the curing of the binder composition is effected at elevated temperatures and under applied pressure.

The method used to apply the elevated temperatures and pressure may be varied depending on the type of board, apparatus and the thickness of the board. Simply subjecting a mattress of resinated fibres to a hot press may be sufficient for thinner boards as the formed board should have a consistent fibre and resin density. Such a press system may be used to form boards with a final thickness of up to 24 mm, such as 8, 12, 14 and 18 mm boards. Such boards may be formed in continuous feed systems or to produce boards of a fixed size. Continuous feed systems may compress the mattress between two faces, whereby the mattress travels along and is supported by the lower face and the gap between the lower face and an upper face decreases as the mattress passes between the two faces. Boards over 24 meters may be produced with such a system.

Thicker boards may require the application of different pressures and temperatures over the manufacturing process of the board. A number of continuous presses allow the programming of pressing profiles whereby the mattress of resinated fibres can be subjected to different pressures and temperatures during the manufacturing process. In essence such machines allow the gap between the faces to be increased or decreased to apply different pressures to the mattress as it travels along the lower face. The speed at which the mattress travels and the temperatures applied to the board may also be varied to provide a desired pressing profile. A useful pressing profile for the manufacture of thicker boards (such as 25 to 32 mm boards) is to quickly apply a high pressure to the mattress (i.e. the front upper face is set at a high incident angle and a small gap between the face) and then decrease the pressure (i.e. increase the gap between the faces of the next portion machine) and then gradually increase the pressure on the mattress as it passes between the remainder of the machine (i.e. a low incident angle gradually reducing the distance between the faces in the latter portion of the machine). Such a profile can provide thicker boards having a more consistent resin fibre density improving the quality and machineability (such as the ability to use a router on the edge) of the boards.

Typically the binder composition will be present in the substrate in the range of from 3 to 40% by weight. The additional rate of the binder composition will generally be dependant upon the physical properties which are required for the substrate and will be dependant upon the nature of the cellulose particles. Preferably the binder composition is present in the composite board in the range of from 5 to 30% by weight, more preferably from 10 to 18% by weight. Typically, based on the amount of inorganic salt present in the resin of the binder composition, the amount of salt present in the finished product will be in the ratio of 0.2 to 6%, more preferably 0.3 to 3%, and more preferably 0.5 to 2.0%, and more preferably 0.6 to 1.8% by weight based on the weight of the substrate. For example a resin formulation comprising 13% of the total mass of the substrate may comprise 5%, by weight of the resin, of a sulphate salt, i.e. 0.65% by weight of the substrate.

To facilitate an understanding of the invention a typical process involving the formation of MDF and particle boards utilising an MUF resin according to the invention will be described. However, it is to be understood that the invention is also applicable to other formaldehyde-based resins and composite panels.

As mentioned previously, the preferred formaldehyde-based resin for use in manufacturing the substrate according to the present invention are MUF resins. A typical MUF resin would be prepared according to the following methodology.

In a typical MUF resin manufacturing process, formaldehyde is charged into a reactor and diluted with water to the required strength, typically 40-50% w/w. The temperature is adjusted to the range 30-40° C. and the pH to greater than 9. To the stirred mixture melamine and urea are charged in such quantities to adjust the mole ratio of amine to formaldehyde to the desired ratio, typically in the range 1.4 to 1.8. The reaction mixture is heated to the desired condensation temperature, typically 90-100° C. The pH is maintained at the desired level, typically above 8.5 and the temperature held until the desired viscosity is achieved. The pH of the resin is then adjusted to greater than 9.5 to stop condensation and the resin cooled to ambient temperature.

The processes for the manufacture of panels of RWS such as MDF or particleboard are well known to those skilled in the art, and the following example is given as an illustration. The typical MDF process involves a number of sequential steps: —fibre preparation, resination of the fibre, drying of the resinated fibre, deposition of the fibre into a mattress form, and consolidation under heat and pressure in a hot press.

The resin and other ingredients (wax, hardeners, additives) may be introduced separately, or as mixtures, and at various points along the production process.

Conditions which prevail will vary largely, dependent on the process equipment and the requirements and thickness of the end panel product. Control of moisture content is very important, but typically resinated fibre is within the range 5-14% before hot pressing. Resin loadings commonly used are 5-20%, and more typically 8-15% for standard density panels (650-800 kg/m³). Press time, temperature and pressure can be adjusted to meet production and economic outcomes.

After pressing, the panels are generally sanded to provide a smooth finish, and 180 grit paper is normally sufficient.

A similar process may be used to prepare particle boards. However, to make particle board, the resin is applied to both fine surface and coarser core fractions of wood chip. These are then formed so that a fine chip finish is present at the top and bottom surfaces of the panel, with a coarser middle layer. The formed mattress is consolidated under heat and pressure, and the panel sanded to provide a smooth finish. Process variables are controlled in a similar manner to that for MDF production, and options for introduction of resin and additives are also similar to those available for MDF.

According to an aspect of the invention, there is provided a process for preparing a powder coated reconstituted cellulosic substrate comprising:
providing a reconstituted cellulosic substrate comprising cellulose based particles and a cured formaldehyde based resin, wherein an inorganic salt is dispersed throughout said substrate;
applying a powder coating composition to at least one surface of said substrate; and
curing said powder coating composition.

Preferably the inorganic salt is dispersed throughout the formaldehyde resin. Preferably the inorganic salt is a sulphate salt, and most preferably sodium sulphate.

The powder coating may be applied to the reconstituted cellulosic substrate using any suitable electrostatic technique known to the art. Preferably the powder coating composition is applied using a technique which minimises the temperatures to which the coated substrate is subjected during curing of the coating. Preferred methods involve the use of UV curable powder coatings, powder coatings which cure at low temperatures, such as those including low temperature curing agents or a combination of both UV and low temperature curing coatings.

The powder coating utilised may be any suitable commercially available powder coating composition. Typically, the powder coating will be based on polyester, epoxy, hybrid blends of polyester and epoxy, polyurethane and other suitable resins. Preferably, it will be UV curable.

The coatings are generally prepared by adding the required amounts of the raw materials into a premixer in which the ingredients are mechanically mixed, usually with a metal blade, to form a homogeneous mixture. This premix material passes through an extruding process. In this process the mixture is processed under heat (usually between 80° C. and 140° C.) and compounded using mechanical shear. This causes the powder coating composition to melt and act like a semi-liquid, and allows the ingredients to be intimately mixed into the powder coating composition. After leaving the extruder the material is cooled, generally on a chiller belt. The cooled mixture is then milled (ground) to the required particle size distribution for good application. A standard particle size distribution ranges from 2 to 200 microns, preferably 10 to 150 microns and typically around a medium size of 50-60 microns.

The coating powder is typically applied to achieve a cured thickness of 0.04 to 0.6 mm, and preferably less than 0.1 mm. The powder is typically applied at a thickness of from 0.08 mm to 0.13 mm. The substrate could be coated with multiple layers to increase the thickness of the coating.

Vertical (hanging substrate) or horizontal coating systems could be used in the coating process. Each system has advantages. Horizontal powder coating systems, such as that described in US 2003/0211252, may be of particular use with longer lengths of substrate than could be reasonably attached to a hanging conveying system and should permit the powder coating of the main contact face and edge faces. Hanging systems allow the substrate to be entirely coated in a single pass with multiple electrostatic guns that apply the powder to all sides. Alternatively, electrostatic guns could be used to spray the powder on at least one face of a suspended substrate. Horizontal systems can be used to provide a wholly coated substrate in sequential powder coating steps.

The powder coating composition may contain colour pigments, extender pigments, cross-linkers and other additives. Examples of pigments and fillers include metal oxides, such as titanium oxide, iron oxide, zinc oxide and the like, metal hydroxides, metal powders, sulphides, sulphates, carbonates, silicates such as aluminium silicate, carbon black, talc, kaolines, barytes, iron blues, lead blues, organic reds, organic maroons and the like.

A slip-enhancing additive may be included to improve coating wear characteristics such as that described in U.S. Pat. No. 5,925,698.

Powder coating compositions may contain other coating modifiers such as polytetrafluoroethylene modified waxes, polyethylene waxes, polypropylene waxes, polyamide waxes, organosilicones and blends of the above.

The powder coating can be applied by any suitable electrostatic technique. The two major techniques used are the corona electrostatic technique and the triboelectrostatic technique. According to the corona electrostatic technique the powder particles are given an electric charge as they come out of the end of a powder coating corona gun by electrodes located at the end of the gun tube. The electrodes are powered by a power-pack which can generate up to 100,000 V (100 KV). The usual working range for voltage is 50 to 100 KV. The powder is sprayed (powder is carried in a stream of air) at the earthed composite panel. The charge on the powder particles allows the powder particles to adhere to the substrate. After the powder coating is sprayed, a baking process is required to melt and chemically react and cross-link (creating a thermoset paint finish) the powder coating resin and the cross-linker.

The triboelectrostatic technique involves a tribogun which also works by charging the powder particles towards an earthed panel. The charge in this case is not generated by a power pack. The tribogun is generally a long polytetrafluoroethylene (PTFE) tube. Friction is generated between the powder coating and the PTFE tube and a charge on the powder is generated by electron removal.

A technique for powder coating the substrate of the invention involves the use of UV curable powder coatings. With such coatings, the powder is applied to the substrate and heated to and above the melting point of the powder coating composition. The temperature achieved in the melting phase is usually between 90° C. and 160° C. The melting phase is conducted by either infrared (IR) heating oven or convection gas or electric heating oven, or a combination of the two systems. After melting and flow out of the powder stage the coated panel is then passed under a UV cure oven. At this stage the coating is irradiated with UV light. The UV light phase is generated by either a mercury lamp or a gallium doped mercury lamp with wavelengths of between 205 and 405 nm.

Photo-initiators suitable for inclusion in UV powders include aromatic carbonyl compounds, such as benzophenone and alkylated or halogenated derivatives, anthraquinone and its derivatives, thioxanthone and its derivatives, benzoin ethers, aromatic or non-aromatic alphadiones, benzol dialkyl acetals, acetophenone derivatives and phosphine oxides.

The UV cure powder coatings can be applied to the substrate using similar techniques to standard coatings which require baking.

Combination UV and low temperature cure compositions use a combination the two techniques described above. U.S. Pat. Nos. 5,922,473 and 6,005,017 includes a more detailed description of such techniques.

The powder coating process may also include other techniques used to improve the adherence of the powder coating to the substrate such as pre-heating the substrate for, by example 5 minutes at 70° C., or the application of a burst of steam shortly before coating. Low temperature curing techniques can be enhanced by the use of localised heating with IR lamps which reduce the heat exposure of the substrate. Hg containing lamps have been found to be effective for UV curing.

Some examples of some typical powder coating formulations are provided below.

### Typical UV Cure Powder Coating

| | |
|---|---|
| UV Cure Resin | 50-95% |
| UV Initiator - Type 1 | 1-3% |
| UV Initiator - Type 2 | 1-3% |
| Pigments | 1-30% depending on colour |
| Additives | 0-5% as required |

### (For Type 1 and Type 2 UV Initiators—See Below)

The UV cured resin will generally have the following properties:

| | |
|---|---|
| Glass transition Temperature of: | 50 +/− 10° C. |
| Unsaturated equivalent weight | 1300 g/eq +/− 200 |
| Cone/Plate Viscosity (175° C.) | 6000 mPa · s +/− 1000 |

The UV curing resin is generally an amorphous resin that can be cross-linked by a free radical polymerisation mechanism. The coating resin may contain unsaturated functional groups (possibly methacrylic and acrylic unsaturation).

The UV initiators are added to start the free radical polymerisation mechanism, upon absorption of the UV irradiation energy. These can include but are not exclusive to (Type 1) α-hydroxyketone types, i.e. 1-(4-(2-Hydroxyethoxy)-phenyl)-2-hydroxy-2-methyl-1-propane-1-one and (Type 2) BAPO (Bis-cylophoshinoxide), i.e. Bis (2,4,6-trimethylbenzoyl)-phenylphosphineoxide. Other additives can be added as required.

### Typical Low Bake Powder Coatings

Low bake powder coatings are designed to cure at temperatures between 90° C. (or less) and 160° C. for between 10 and 40 minutes total oven time (in a conventional gas or electric fired oven). IR cure of low bake powder will be much faster (from 30 seconds to 5 minutes). Low bake powder coatings can be different chemistries. Epoxy and acrylic resins are commonly used.

### Typical Low Bake Formulation

| | |
|---|---|
| Pigments | 0-40% |
| Epoxy resin | 40-90% |
| Cross-Linker | 0-15% |
| Additives | 0-10% |

The epoxy resin generally has the following properties:

| | |
|---|---|
| Epoxide equivalent weight: | 400-900 |
| Viscosity: | 500-5000 Centistokes at 150° C. |
| Softening point: | 70-110° C. |

Various cross-linkers can be used including but not limited to dicyandiamide or adducts of 2-methyl imidazole.

### Typical Standard Polyester Powder Coating

| | |
|---|---|
| Polyester | 50-95% |
| Cross-linker | 2-10% |
| Pigments | 1-40% depending on colour |
| Additives | 0-5% as required |

The polyester resin usually has the following properties:

| | |
|---|---|
| Acid Value (or hydroxy value) | 20-80 |
| Viscosity | 200-700 dPa · s (at 165° C.) |
| Glass Transition Temperature | 50-70° C. |

The present invention will now be described with reference to the following non-limiting examples.

### EXAMPLES

### Example 1

### Preparation of Resin

2000 g of 54% w/w formaldehyde was added to a reactor and diluted to 42% strength with 571 g water. The temperature was adjusted to 30° C. and the pH adjusted into the range 9.4-9.7. 1763 g melamine was charged into the agitated reactor, followed by 339 g urea. The reacting mixture was heated to 95° C. and the resin condensed at a pH between 9.8 and 9.2. The resin was cooked until a water tolerance of 150% was reached. The resin was quenched to a pH of 9.3 and 5% salt on total reactant mass was added and stirred until dissolved. The resin was then cooled to ambient temperature, producing a resin with 63% solids.

Resin formulation (A) contained sodium sulphate as the salt. Resin formulation (B) contained sodium chloride. Resin formulation (Control) was manufactured without any salt.

### Example 3

### Preparation of Thin MDF Panels

MDF panels were made using wood fibre which was sprayed with 13% resin on dry fibre mass, 0.5% wax emulsion and sufficient water were added to bring the glued moisture content to the range of 12-14%. A mattress of resinated fibre was laid out on a metal platen and placed into a hot press where heat and pressure was applied to form thin (12 and 18 mm thickness) panels. The panels were allowed to cool and cut into sections of 13 cm×26 cm.

Panels were formed using Resin formulations (A), (B) and (Control) from example 1. The density of the panels was between 700 to 720 kg/m² and had an internal bond strength greater than 1.0 N/m². The 18 mm panels were tested and found to have a modulus of rupture greater than 20 N/m². The internal bond strength was measured in accordance with the Interim Australian/New Zealand Standard AS/NZS 4266.6(Int):2001. The modulus of rupture was measured in accordance with the Australian/New Zealand Standard AS/NZS 4266.5:2004.

### Example 4

### Preparation of Thick MDF Panels

MDF panels were made using radiata pine fibre which was sprayed with 13% resin on dry fibre mass (approximately 3% moisture), 0.5% wax emulsion and sufficient water were added to bring the glued moisture content to the range of 12-14%. A mattress of resinated fibre was laid out on a metal platen and formed into panels using a variable pressure press. The pressing profile used initially and quickly subjected the fibres a high pressure compression, and then reduced the compression before slowly increasing the compression. The panels were allowed to cool and cut into sections of 13 cm×26 cm. The resultant thick boards (25 and 32 mm thickness) were found to be highly machineable and had a consistent and even charge density.

Panels were formed using Resin formulations (A), (B) and (Control) from example 1. The density of the panels was from 700 to 720 kg/m² with an internal bond strength greater than 1.0 N/m² when measured in accordance with the earlier mentioned standards.

### Example 5

### Powder Coat Formulation

A powder coating formulation was prepared by combining the following ingredients, and extruding and pulverising in accordance with standard methods.

| Component | wt % (based on weight of powder) |
|---|---|
| Bisphenol A epoxy resin (Type 2-4) | 60.00 |
| Dicyandimide (curing agent) | 6.60 |
| Acrylic (flow control agent) | 0.8 |
| PTFE wax | 2.5 |
| Pigments and fillers | 27 |

The powder was formulated to provide a grey textured finish. Curing was achieved in 20 minutes at 150° C.

### Example 6

### Powder Coating

20 g of the powder coating powder of Example 5 was applied with a triboelectric gun to panels from example 2. The coating was applied to three samples of panels of each thickness and prepared from the resin formulation (A), three samples of panels of each thickness prepared from the resin formulation (B) and three samples of panels of each thickness prepared with out salt from the resin formulation (Control). All panel pieces had the same mass and surface area. The mass of powder adhering to each piece was measured by weighing the pieces before and after application.

The average transfer mass of the salt containing panels was found to be significantly larger than the control panels. The transfer efficiency (mass of powder adhering to the panel/total mass of applied powder) the control panels was found to be 20%. The transfer efficiency of the sodium sulphate salt containing panels of example 2 was found to be 30%.

All panels were closely inspected and the panels with salt containing resin were found to be coated all edges with no noticeable reduction in coverage across the edge of the panel. In contrast the control panels were found to have a 1-2 mm leading edge that was devoid of powder and bare wood showed through.

### Example 7

### Conductivity Measurements

The conductivity of the salt containing panels of Example 2 and the control panel were measured using standard equipment. Before taking the measurement each section was soaked with approximately 5 ml of water and then allowed to become touch dry. The conductivity of the salt containing panels of Example 2 was at least an order of magnitude greater than that of the control panel.

### Example 8

### Particle Board

A control particle board was made using standard techniques manufacturing techniques. A salt containing particle board was made in the same way, other than sodium sulphate was mixed into resin used in making the board. The resin comprised approximately 15% by weight of the board, and the salt comprised approximately 7% by weight of the resin, so the formed particle board would contain approximately 1% by weight of sodium sulphate.

The boards were powder coated with the powder coat formulation of Example 2. The boards were inspected and it was found that the salt containing board had satisfactory coverage including at the edges, whilst the control board had poor coverage at the edges with the underlying substrate visible.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

Those skilled in the art will appreciate that the invention described herein is susceptible to variations and modifications other than those specifically described. It is to be understood that the invention includes all such variations and modifications which fall within its spirit and scope. The invention also includes all of the steps, features, compositions and compounds referred to or indicated in this specification, individually or collectively, and any and all combinations of any two or more of said steps or features.

The reference to any prior art in this specification is not, and should not be taken as, an acknowledgment or any form or suggestion that that prior art forms part of the common general knowledge in Australia.

1. A process for preparing a powder coated reconstituted cellulosic substrate comprising:
providing a reconstituted cellulosic substrate comprising cellulose based particles and a cured formaldehyde based resin, wherein an inorganic salt is dispersed throughout the substrate;
applying a powder coating composition to at least one surface of said substrate; and
curing the powder coating composition.

2. A process according to claim 1 wherein the salt is not a chloride containing salt.

3. A process according to claim 1 wherein the salt is an inorganic sulphate salt.

4. A process according to claim 2 wherein the salt is selected from sodium sulphate, potassium sulphate, calcium sulphate, ammonium sulphate and sodium thiosulphate.

5. A process according to claim 1 wherein the inorganic salt is present in an amount sufficient to increase the conductivity of the panel to be greater than 10⁻¹⁰ (Ωm)⁻¹.

6. A process according to claim 1 wherein the salt is present in an amount from 0.2 to 6% by weight of the substrate.

7. A process according to claim 6 wherein the salt is present in an amount from 0.5 to 2% by weight of the substrate.

8. A process according to claim 1 wherein the cured formaldehyde based resin comprises of from 3 to 40% by weight of the substrate.

9. A process according to claim 1 wherein the inorganic salt comprises 1 to 15% by weight of the formaldehyde resin.

10. A process according to claim 1 further comprising:
providing a binder composition comprising a formaldehyde based resin and an inorganic salt,
blending cellulose based particles with the binder composition, and
curing the blend to provide the reconstituted cellulosic substrate with inorganic salt dispersed throughout the substrate.

11. A process according to claim 10 wherein the inorganic salt comprises 1 to 15% by weight of the binder composition.

12. A process according to claim 1 wherein the formaldehyde based resin is selected from UF resins, PF resins, PUF resins, MUF resins, PMUF resins and PMF resins.

13. A process according to claim 12 wherein the formaldehyde based resin is a MUF resin.

14. A process according to claim 1 wherein the substrate is medium density fiberboard, high density fiberboard, particle board, chip board, flake board, hard board, strand board, wafer board or oriented strand board.

15. A binder composition for use in the manufacture of a reconstituted cellulosic substrate comprising a formaldehyde-based resin and an alkali metal sulphate salt.

16. A binder composition for use in the manufacture of a reconstituted cellulosic substrate comprising a melamine urea formaldehyde resin and an alkali metal sulphate salt.

17. A reconstituted cellulosic substrate when used in a powder coating process, wherein an inorganic salt is dispersed throughout said substrate.

18. A reconstituted cellulosic substrate for use in a powder coating process, wherein an alkali metal sulphate salt is dispersed throughout said substrate.

19. A reconstituted cellulosic substrate of claim 17 wherein the inorganic salt is not a chloride containing salt.

20. A reconstituted cellulosic substrate of claim 19 wherein the inorganic salt is an inorganic sulphate salt.

21. A reconstituted cellulosic substrate containing formaldehyde-based resin and an alkali metal sulphate salt.

22. A powder coated reconstituted cellulosic substrate containing formaldehyde-based resin and an inorganic sulphate salt.

23. A powder coated reconstituted cellulosic substrate made according to the process of claim 1.

24. A reconstituted cellulosic substrate of claim 18 wherein the alkali metal salt is not a chloride containing salt.

25. (canceled)
